(19) United States
(12) Patent Application Publication
(10) Pub. No.: US 2026/0151846 A1
(43) Pub. Date: Jun. 4, 2026

(54) METHOD FOR JOINING DISSIMILAR MATERIALS WITH EXCELLENT JOINING STRENGTH AND BONDED STRUCTURE MANUFACTURED THEREBY

(71) Applicants: Hyundai Motor Company, Seoul (KR); Kia Corporation, Seoul (KR)

(72) Inventor: Wookjin Oh, Hwaseong-si (KR)

(21) Appl. No.: 19/029,129

(22) Filed: Jan. 17, 2025

(30) Foreign Application Priority Data
Nov. 29, 2024 (KR) 10-2024-0175257

(51) Int. Cl. B23K 11/00; B23K 11/20; B23K 103/20; F16B 5/08

(52) U.S. Cl. CPC B23K 11/0066; B23K 11/20; F16B 5/08; B23K 2103/20

(57) ABSTRACT

The present disclosure relates to a method for joining dissimilar materials. The method includes locating a second plate on a first plate. The second plate is a non-ferrous metallic plate and the first plate is a steel metallic plate. The method also includes forming a hole in the second plate, locating a hollow rivet in the hole, and welding the first plate and the hollow rivet together.

### CROSS-REFERENCE TO RELATED APPLICATIONS

This present application claims the benefit of priority to Korean Patent Application No. 10-2024-0175257, filed on Nov. 29, 2024, in the Korean Intellectual Property Office, the entire disclosure of which is incorporated herein by reference.

### TECHNICAL FIELD

The present disclosure relates to a method for joining dissimilar materials using a hollow rivet and welding, and a bonded structure manufactured thereby.

### BACKGROUND

In recent years, the automotive industry has been innovating materials to achieve a goal of light weight and securing collision safety. In particular, a proportion of the use of ultra-high strength steel such as lightweight materials, such as aluminum, and hot stamping steel is increasing. The application of these dissimilar materials may reduce the weight of the vehicle and provide high strength and safety, making it an important trend of vehicle development.

However, dissimilar materials such as aluminum and hot stamping steel have very different physical and chemical properties, making them difficult to join. The aluminum is light and has excellent corrosion resistance, but the aluminum has a relatively low strength, and the hot stamping steel is advantageous for collision safety due to ultra-high strength, but the hot stamping steel is characterized by being heavy and low-workability. Therefore, dissimilar material joining technology is required to apply dissimilar materials with different characteristics. In particular, this technology is applied to a main component of the automotive body (door, frame, subframe, etc.), and a rework (repair) plan to solve a joining failure that may occur in a production process is also considered.

In related art, blind riveting technology has been used to repair/strengthen the dissimilar materials joining or bad joining portions. The blind riveting first processes holes at a joining site and inserts the rivet, and then mechanically fixes the joining portion as a mandrel inside the rivet is pulled and plastically deformed. Thereafter, the blind riveting is a riveting method that joins the dissimilar materials by removing the mandrel. The blind riveting is a physical fixation method, so the blind riveting can overcome a difference in physical and chemical characteristics of the material, and has an advantage of a relatively simple process. However, when the hot stamping steel is used, a strong drill for the formation of holes is required due to the high strength. Further, the drill is also worn out quickly and due to the high strength, a long time is also required. In addition, because the hot stamping steel is joined by plastic deformation, it is difficult to secure a predetermined joining strength or more. Thus, research on bonding methods between dissimilar materials that can satisfy the workability and economy while securing the joining strength between the dissimilar materials continues.

### SUMMARY

The present disclosure relates to a method for joining dissimilar materials with excellent workability using a hollow rivet and welding, and an excellent joining strength and a bonded structure manufactured thereby.

An embodiment of the present disclosure has been developed to consider problems in the related art described above, and solve such problems. An embodiment of the present disclosure can provide a method for joining dissimilar materials, which may secure an excellent joining strength through welding after forming holes in only non-ferrous metallic plates unlike forming holes in a hot stamping steel, which is a steel metallic plate, through existing blind riveting, and a bonded structure manufactured thereby.

A method for joining dissimilar materials according to an example embodiment of the present disclosure may include: locating a second plate that is a non-ferrous metallic plate on a first plate that is a steel metallic plate; forming holes in the second plate; locating a hollow rivet to fill the hole; and welding the first plate and the hollow rivet.

A dissimilar material bonding structure according to an example embodiment of the present disclosure may be manufactured through the method for joining dissimilar materials according to various example embodiments of the present disclosure.

According to a method for joining dissimilar materials of an embodiment of the present disclosure, melt welding may be possible by using a hollow rivet.

In an embodiment of the present disclosure, holes can be formed only in the nonferrous metallic plates to prevent wear of the steel metallic plate.

Accordingly, processability and workability may be excellent. In an embodiment of the present disclosure, wear of the drill can be prevented, so it can be economical.

According to a method for joining dissimilar materials of an embodiment of the present disclosure, joining strengths equal to or more than those of dissimilar materials joined by a blind riveting scheme may be implemented.

According to a method for joining dissimilar materials of an embodiment of the present disclosure, by using carbon dioxide in a welding step, it can be economical, and a work speed can be fast, so it may be efficient.

### BRIEF DESCRIPTION OF THE DRAWINGS

The above and other features and advantages of example embodiments of the present disclosure can become apparent from the detailed description of the following example embodiments in conjunction with the accompanying drawings, in which:

FIG. 1 is a flowchart of a method for joining dissimilar materials according to an embodiment of the present disclosure;

FIG. 2 is a schematic view schematically illustrating a method for joining dissimilar materials according to an embodiment of the present disclosure;

FIG. 3 is a schematic view illustrating a step of locating a second plate on a first plate according to an embodiment of the present disclosure;

FIG. 4 is a schematic view illustrating a step of forming holes in the second plate according to an embodiment of the present disclosure;

FIG. 5 is a schematic view illustrating a step of locating a hollow rivet to fill a hole according to an embodiment of the present disclosure;

FIG. 6 is a perspective view of a hollow rivet according to an embodiment of the present disclosure;

FIG. 7 is a schematic view illustrating a step of welding the first plate and the hollow rivet according to an embodiment of the present disclosure; and

FIG. 8 is a graph showing a result according to Experimental Example 1.

### DETAILED DESCRIPTION OF ILLUSTRATIVE EMBODIMENTS

If it is not contrarily defined, terms used herein including technological or scientific terms can have same meanings as those generally understood by a person with ordinary skill in the art. Terms that are defined in a generally used dictionary can be interpreted to have a same meaning as a meaning in the context of the related art.

In the present disclosure, terms such as “first,” “second,” and the like, can be used for describing various components, and the components are not necessarily limited by such terms. Such terms can be used merely to discriminate one component from another component. For example, a first component may be referred to as a second component, and similarly, the second component may be referred to as the first component without departing from the scopes of the present disclosure.

Terms used in the present disclosure are used to describe specific example embodiments, and are not intended to necessarily limit the present disclosure. A singular form can include a plural form if there is no clearly opposite meaning in the context. In the present disclosure, it can be understood that the terms “include”, “have”, and “comrpise” indicate that a feature, a number, a step, an operation, a component, a part, or the combination thereof, described in the specification is present, but does not exclude a possibility of presence or addition of one or more other features, numbers, steps, operations, components, parts, or combinations thereof, in advance.

Hereinafter, a method for joining dissimilar materials according to an example embodiment of the present disclosure will be described in detail with reference to the accompanying drawings.

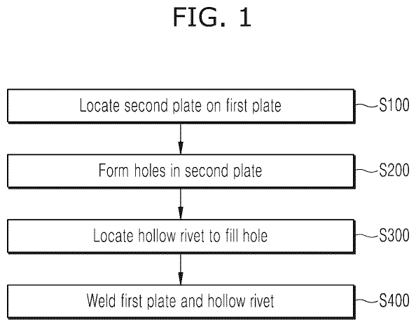

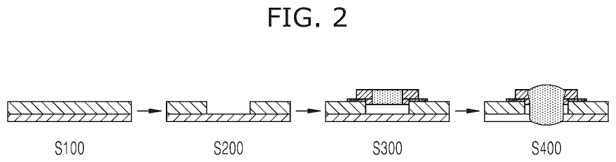

First, the method for joining dissimilar materials of an embodiment of the present disclosure is described with reference to FIGS. 1 and 2.

FIG. 1 is a flowchart of a method for joining dissimilar materials according to an embodiment of the present disclosure.

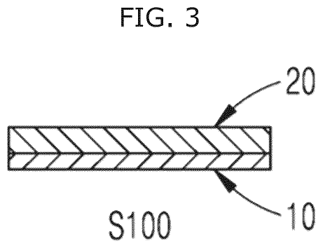

FIG. 2 is a schematic view schematically illustrating the method for joining dissimilar materials of FIG. 1, according to an embodiment of the present disclosure. FIGS. 3-5 and 7 illustrate individual operations or steps of the method for joining dissimilar materials of FIGS. 1 and 2 in more detail, according to an embodiment of the present disclosure.

Referring to FIGS. 1-5 and 7, a method for joining dissimilar materials according to an embodiment of the present disclosure may include an operation S100 of locating a second plate 20 on a first plate 10, an operation S200 of forming holes 21 in the second plate 20, an operation S300 of locating a hollow rivet 30 into the hole 21, and an operation S400 of welding the first plate 10 and the hollow rivet 30 together.

In the operation S100 of locating the second plate 20 on the first plate 10 according to an embodiment of the present disclosure, the first plate 10 and the second plate 20 may be plates prepared for new joining.

In another example, the first plate 10 and the second plate 20 may be bonded plates that are already joined, but are in a state in which rework (repair) is required due to a weakened joining strength, body repair after a collision, etc.

The operation S100 of locating the second plate 20 on the first plate 10 according to an embodiment of the present disclosure is schematically illustrated in FIG. 3. In FIG. 3, it is illustrated that the first plate 10 and the second plate 20 are stacked without a space therebetween, but an embodiment of the present disclosure is not limited thereto, and a fine space may also be formed between both plates.

In an embodiment of the present disclosure, the first plate 10 may be a steel metallic plate. In one example, the first plate 10 may be any one of a steel sheet, a stainless-steel sheet, a high-strength steel sheet, or an ultra-high strength steel sheet. Preferably, the first plate 10 may be hot stamping steel that is the ultra-high strength steel, for example.

Hot stamping can refer to a manufacturing method that austenizes a material by heating steel at a temperature of approximately 950° C. or higher, and then press-processes and cools the material, and transforms the material to a martensite. The hot stamping steel manufactured as above may have excellent strength, and have a high processability. Accordingly, when the hot stamping steel is applied to a vehicle, collision safety may be enhanced, and a vehicle body may be lighter.

The first plate 10 according to an example embodiment of the present disclosure may be hot stamping steel including boron.

In an embodiment of the present disclosure, the second plate 20 may be a nonferrous metallic plate. In one example, the second plate 20 may be an aluminum plate or a magnesium plate. Preferably, the second plate 20 may be the aluminum plate, for example.

The aluminum plate may be an aluminum alloy wrought such as 2000 based, 4000 based, or 6000 based, but a type thereof is not limited thereto.

The aluminum plate may be an aluminum alloy casting material for Al-Si die casting, but the type thereof is not limited thereto.

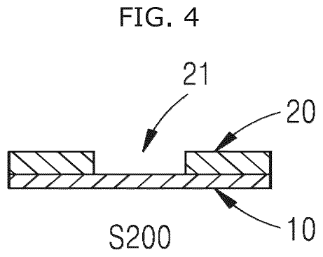

In an embodiment of the present disclosure, as described above, the first plate 10 and the second plate 20 can be located, and then the holes 21 may be formed in the second plate 20. Specifically, in the operation S200 of forming the holes 21 in the second plate 20 according to an embodiment of the present disclosure, the hole 21 that vertically penetrates the second plate 20 may be formed through a drill. The operation S200 of forming the holes 21 in the second plate 20 according to an embodiment of the present disclosure is schematically illustrated in FIG. 4. In an alternative embodiment, the operation S200 of forming the holes 21 in the second plate 20 can be performed before the operation S100 of the first plate 10 and the second plate 20 being located relative to each other. For example, the holes 21 may be stamped rather than drilled.

In an embodiment of the present disclosure, the hole 21 is not formed in the first plate 10 that is the steel metallic plate to prevent wear of the steel metallic plate, and wear of the drill used to form the hole 21 may also be prevented.

In an embodiment of the present disclosure, the drill is not limited to any type, and because the first plate 10 that is the steel metallic plate is not processed, a hand drill may be used.

In one example, as the hand drill, a cobalt material spot drill blade may be used, but the present disclosure is not limited thereto. Through this, the hole 21 may be formed in the second plate 20.

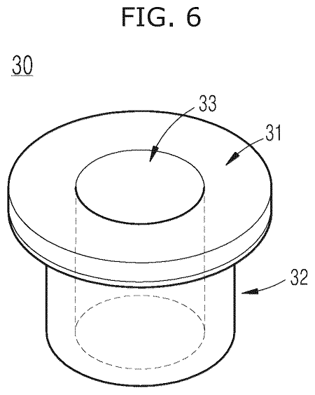

As described above, a diameter of the hole 21 formed in the second plate 20 may be 6 mm to 15 mm, for example. An example hollow rivet 30 is shown in FIG. 6. The diameter of the hole 21 may have the same value as a diameter of a body portion 32 of a hollow rivet 30.

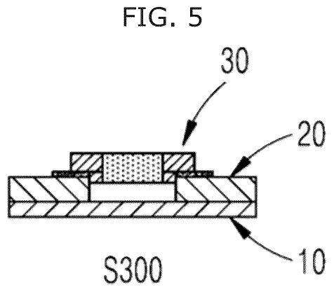

In an embodiment of the present disclosure, as described above, the hole 21 may be formed in the second plate 20, and then the hollow rivet 30 may be located in the hole 21. That is, in the operation S300 of locating the hollow rivet 30 to fill the hole 21 according to an embodiment of the present disclosure, the hollow rivet 30 may be located to be fitted and filled in the hole 21 of the second plate 20. The operation S300 of locating the hollow rivet 30 into the hole 21 according to an embodiment of the present disclosure is schematically illustrated in FIG. 5.

FIG. 6 is a perspective view of the hollow rivet 30 according to an embodiment of the present disclosure. The hollow rivet 30 of an embodiment of the present disclosure may include a head portion 31 and a body portion 32. The head portion 31 may be a form that protrudes from an upper end of the body portion 32.

Referring to FIG. 6, a diameter of the head portion 31 of the hollow rivet 30 may be larger than a diameter of the body portion 32 in an embodiment of the present disclosure. As described above, the diameter of the body portion 32 may have the same value as the diameter of the hole 21, or the hole 21 may be sized and configured to receive the body portion 32 of the hollow rivet 30 therein, or the body portion 32 of the hollow rivet 30 may be sized and configured to fit into the hole 21, for example.

When such a structure is provided, the hollow rivet 30 may be fitted into the hole 21, and a bottom surface of the head portion 31 that protrudes may be overlapped with a part of a top surface of the second plate 20.

In the operation S300 of locating the hollow rivet 30 to fill the hole 21 according to an embodiment of the present disclosure, the hollow rivet 30 may be fixed by applying an adhesive onto the second plate 20 so as to comprise a part where the top surface of the second plate 20 and the bottom surface of the head portion 31 that protrudes are overlapped.

The adhesive may be an epoxy resin-based adhesive.

In an embodiment of the present disclosure, the adhesive can be applied to the hollow rivet 30 and/or the second plate 20, to attach the hollow rivet 30 on the second plate 20.

The adhesive may be cured by welding heat generated in the welding step to be described below.

The hollow rivet 30 according to an embodiment of the present disclosure may include a penetration portion 33 vertically penetrating the body portion 32 at a cross-sectional center. The penetration portion 33 may be a cylindrical form that is formed to have a predetermined diameter based on a central axis of the hollow rivet 30. The diameter of the penetration portion 33 may be smaller than the diameter of the body portion 32.

The hollow rivet 30 according to an embodiment of the present disclosure may include the penetration portion 33, and may be filled with welding material in the welding operation to be described below. As a result, in an embodiment of the present disclosure, the hollow rivet 30 and the first plate 10 may be strongly joined.

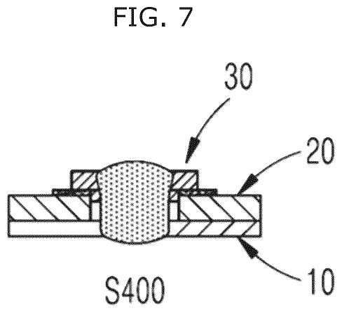

In the operation S400 of welding the first plate 10 and the hollow rivet 30, a welding rod may be located along or into the penetration portion 33 of the hollow rivet 30, and the welding metal may be welded in a vertical direction of the first plate 10 so as to partially or completely, or overflowingly fill the penetration portion 33 of the hollow rivet 30. The operation S400 of welding the first plate 10 and the hollow rivet 30 according to an embodiment of the present disclosure is schematically illustrated in FIG. 7.

In an embodiment of the present disclosure, welding may be performed in a short-circuit transfer scheme in which the welding metal fills the penetration portion 33 of the hollow rivet 30 in an upward direction from the first plate 10 by locating the welding rod along or into or through the penetration portion 33 of the hollow rivet 30. The short-circuit transfer can refer to a welding method that maintains an arc length to be short so that arc and short-circuit occur alternately to each other, and a phenomenon in which a welding droplet is transferred by a pinch effect of short-circuit current that flows when the welding droplet of the welding rod is shorted to a base material (e.g., the first plate 10 in an embodiment of the present disclosure).

In the operation S400 of welding the first plate 10 and the hollow rivet 30 according to an embodiment of the present disclosure, carbon dioxide may be input through a nozzle (e.g., a nozzle of the welding machine/tool). That is, the operation S400 may be performed by gas arc welding using carbon dioxide. Carbon dioxide may serve to prevent oxidation or nitration of the welding metal during the welding operation.

In an embodiment of the present disclosure, a working speed may be fast by using the gas (carbon dioxide) arc welding, and it may be economical.

A bonded structure of dissimilar materials in an embodiment of the present disclosure may be manufactured through the method for joining dissimilar materials according to various embodiments described above.

Accordingly, using an embodiment of the present disclosure, the joining strength may be equal to or more than that of the existing blind riveting technique.

Hereinafter, an embodiment of the present disclosure will be described in more detail with reference to examples. However, examples and experimental examples below are intended to more specifically describe the present disclosure, and the scopes of the present disclosure is not limited to the examples and experimental examples below. cl Example 1

Dissimilar materials in which the second plate is located on the first plate were prepared. The first plate was SABC1470, which is hot stamping steel, and had a thickness of 1.8 T. The second plate was A6014P-T4F, which was an Al—Mg—Si based alloy (6000 based) among aluminum alloy wroughts, and had a thickness of 1.0 T. A hole having a diameter of 10 mm was formed by using a cobalt material spot drill blade in a hand drill for only the second plate among both prepared plates. Thereafter, an epoxy resin-based adhesive (TEROSON-EP-5065) was applied to an area (including a part where the hollow rivet is overlapped) around the hole in the second plate, and the hollow rivet was attached while being fitting into the hole. Last, a nozzle was located at the center of the hollow rivet, and a KC-28 welding rod (having a diameter of 0.6 mm) was located along a penetration portion, and gas (carbon dioxide) arc welding was performed. As a result, dissimilar materials were finally joined by filling the penetration portion of the hollow rivet with the welding metal from the first plate.

### Example 2

Dissimilar materials were joined through the same method as Example 1 except that A365.0-T6, which is an Al—Si die casting alloy, having a thickness of 3.0 T among the aluminum alloy casting materials was used as the second plate.

### Comparative Example 1

The same first and second plates as Example 1 were prepared. Thereafter, both plates were joined through blind riveting. That is, holes were formed on both the first plate and the second plate, and rivets were inserted, and then the rivets were plastically deformed. Last, dissimilar materials were finally joined by removing a mandrel of the blind rivet.

### Comparative Example 2

The same first and second plates as Example 2 were prepared. Thereafter, both plates were joined through the blind riveting. That is, holes were formed on both the first plate and the second plate, and rivets were inserted, and then the rivets were plastically deformed. Last, dissimilar materials were finally joined by removing the mandrelof the blind rivet.

### Experimental Example 1

### Measurement of Joining Strength

In this experiment, joining strengths of bonded structures manufactured by the joining methods of Example 1, Example 2, Comparative Example 1, and Comparative Example 2 were measured. The joining strength was measured by fixing the bonded structure to a universal testing machine (UTM).

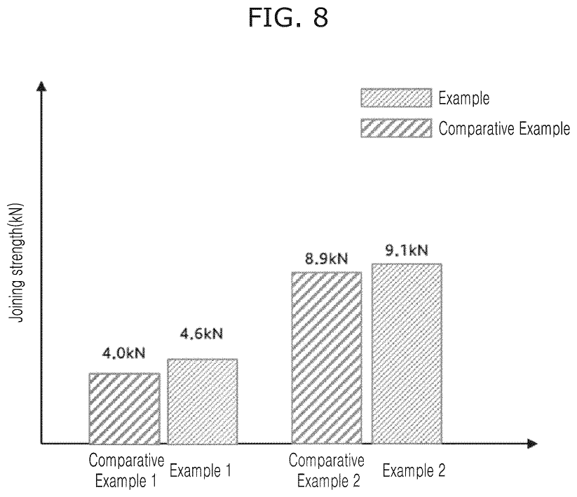

The test results are illustrated in FIG. 8.

Referring to FIG. 8, Example 1 showed a joining strength of 4.6 kN and Comparative Example 1 showed a joining strength of 4.0 kN. Example 2 showed a joining strength of 9.1 kN and Comparative Example 2 showed a joining strength of 8.9 kN.

In the case of Example 1 and Comparative Example 1 using the hot stamping steel and the aluminum alloy wrought, it may be seen that the jointing method according to an embodiment of the present disclosure shows the better joining strength. Even in the case of Example 2 and Comparative Example 2 using the hot stamping steel and the aluminum alloy casting material, it may be seen that the jointing method according to an embodiment of the present disclosure shows the better joining strength.

Through this, when a joining method of an embodiment of the present disclosure is used, it may be seen that a joining strength equal to or larger than the blind riveting used for joining and repair in the related art is secured, and it is confirmed that both workability and economics may be secured by using the gas (carbon dioxide) arc welding.

The present disclosure has been described above with reference to preferred examples (example embodiments) thereof. It can be understood to those skilled in the art that an embodiment of the present disclosure may be implemented as a modified form without departing from an essential characteristics of the present disclosure. Therefore, the disclosed examples should be considered in an illustrative viewpoint rather than a restrictive viewpoint. The scopes of the present disclosure can be defined by the appended claims rather than by the foregoing description, and differences within the scopes of equivalents thereof can be construed as being included in the present disclosure.

What is claimed is:

1. A method for joining dissimilar materials, comprising:
locating a second plate on a first plate, wherein the second plate is a non-ferrous metallic plate and the first plate is a steel metallic plate;
forming a hole in the second plate;
locating a hollow rivet in the hole; and
welding the first plate and the hollow rivet together.

2. The method of claim 1, wherein the first plate is a steel sheet, a stainless-steel sheet, a high-strength steel sheet, or an ultra-high strength steel sheet.

3. The method of claim 1, wherein the second plate is an aluminum plate or a magnesium plate.

4. The method of claim 1, wherein in the forming of the hole in the second plate, the hole is vertically penetrating the second plate and the forming is by drilling with a drill bit.

5. The method of claim 1, wherein a diameter of the hole is 6 mm to 15 mm.

6. The method of claim 1, wherein the hollow rivet comprises:
a body portion;
a head portion that protrudes from an upper end of the body portion; and
a penetration portion vertically penetrating the body portion at a cross-sectional center thereof.

7. The method of claim 6, wherein in the locating of the hollow rivet in the hole, the hollow rivet is fixed to the second plate by applying an adhesive onto the second plate such that a bottom surface of the head portion of the hollow rivet overlaps onto a top surface of the second plate.

8. The method of claim 7, wherein the adhesive is an epoxy resin-based adhesive.

9. The method of claim 1, wherein in the welding of the first plate and the hollow rivet together, a welding rod is located into a penetration portion of the hollow rivet, and the welding rod is welded in a vertical direction of the first plate so that welding metal at least partially fills the penetration portion of the hollow rivet.

10. The method of claim 9, wherein in the welding of the first plate and the hollow rivet together, carbon dioxide is input through a nozzle of a welding tool used for the welding.

11. A dissimilar material bonding structure comprising the first plate and the second plate, wherein the dissimilar material bonding structure is manufactured by the method of claim 1.

12. A method for joining dissimilar materials, comprising:
providing a first plate of a first material;
providing a second plate of a second material, wherein the second material is different than the first material, and wherein the second material is not compatible for being welded with the first material;
providing a hollow rivet of a third material, wherein the third material is compatible for being welded with the first material, wherein the hollow rivet includes a rivet hole extending through the hollow rivet;
locating the second plate on the first plate;
forming a second-plate hole through the second plate;
locating the hollow rivet in the second-plate hole; and
welding the first plate and the hollow rivet together via the rivet hole.

13. The method of claim 12, wherein the second plate comprises a non-ferrous metallic material, and wherein the first plate comprises a steel metallic material.

14. The method of claim 12, wherein the forming of the second-plate hole is performed after the locating of the second plate on the first plate, such that the second-plate hole does not extend through the first plate.

15. The method of claim 14, wherein the forming of the second-plate hole is performed by drilling with a drill bit.

16. The method of claim 12, where the forming of the second-plate hole is performed before the locating of the second plate on the first plate.

17. The method of claim 12, wherein the hollow rivet comprises:
a body portion having a first cylindrical shape; and
a head portion that protrudes from an upper end of the body portion, wherein the head portion has a second cylindrical shape, wherein body portion has a first outer diameter that is smaller than a second outer diameter of the head portion, wherein the rivet hole extends through the head portion and the body portion, wherein an inner diameter of the second-plate hole is larger than the first outer diameter of the body portion, and wherein the inner diameter of the second-plate hole is smaller than the second outer diameter of head portion.

18. The method of claim 12, wherein the locating of the hollow rivet in the second-plate hole comprises adhering the hollow rivet to the second plate.

19. A structure comprising:
a first plate of a first material;
a second plate of a second material, wherein the second material is different than the first material, and wherein the second material is not compatible for being welded with the first material, wherein the second plate is located on the first plate, wherein the second plate includes a second-plate hole extending through the second plate; and
a hollow rivet of a third material, wherein the third material is compatible for being welded with the first material, wherein the hollow rivet includes a rivet hole extending through the hollow rivet, wherein the hollow rivet is located in the second-plate hole, and wherein the first plate is welded to the hollow rivet such that a portion of the second plate is sandwiched between a head portion of the hollow rivet and the first plate at the location of the hollow rivet.

20. The structure of claim 19, wherein the second plate comprises a non-ferrous metallic material, and wherein the first plate comprises a steel metallic material.
